(19) United States
(12) Patent Application Publication
(10) Pub. No.: US 2007/0181444 A1
(43) Pub. Date: Aug. 9, 2007

(54) Nitric oxide sensor

(75) Inventors: Jonathan Bernstein, Cincinnati, OH (US); Rakesh Govind, Cincinnati, OH (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: UNIVERSITY OF CINCINNATI, Cincinnati, OH (US)

(21) Appl. No.: 11/549,425

(22) Filed: Oct. 13, 2006

Related U.S. Application Data
(60) Provisional application No. 60/726,565, filed on Oct. 14, 2005.

(51) Int. Cl. G01F 1/64; G01N 27/26

(52) U.S. Cl. 205/781; 204/415

(57) ABSTRACT

The present invention generally relates to sensors configured to sense concentrations of nitric oxide. The sensors of the present invention generally comprise a selectively permeable membrane, a semi-permeable reference electrode, and a sensing electrode. The membrane generally comprises a dispersed solid electrolyte. The solid electrolyte generally is a nitric oxide trapping agent configured to stabilize the nitric oxide to form stable, oxidizable nitric oxide complexes. The nitric oxide complexes may then diffuse through the membrane and the reference electrode to the sensing electrode where they are oxidized. An electrical current indicative of the concentration of the nitric oxide generated by the oxidation may be transmitted from the sensor to a picoammeter, which may be configured to measure the electrical current and to signal to a user of the sensor the concentration of the nitric oxide.

### CROSS-REFERENCE TO RELATED APPLICATIONS

This application claims the benefit of U.S. Provisional Application Ser. No. 60/726,565 (UVC 0003 MA), filed Oct. 14, 2005.

### BACKGROUND OF THE INVENTION

Embodiments of the present invention generally relate to amperometric sensors configured to sense concentrations of nitric oxide. In addition, the present invention generally relates to methods of measuring concentrations of nitric oxide.

### BRIEF SUMMARY OF THE INVENTION

In accordance with one embodiment, an amperometric sensor generally comprises a selectively permeable membrane, a semi-permeable reference electrode, and a sensing electrode. The membrane is configured to permit the diffusion of nitric oxide through the membrane. This membrane generally comprises a dispersed solid electrolyte, wherein the solid electrolyte is a nitric oxide trapping agent configured to stabilize the nitric oxide by forming stable, oxidizable nitric oxide complexes upon reaction of the trapping agent with the nitric oxide. The semi-permeable reference electrode may be configured to permit the diffusion of the nitric oxide complexes to the sensing electrode and to oxidize substances other than the nitric oxide complexes so as to substantially eliminate interference caused by the other substances in the oxidation of the nitric oxide complexes. The sensing electrode generally is configured to oxidize the nitric oxide complexes, wherein the oxidation generates an electrical current indicative of the concentration of nitric oxide.

In accordance with another embodiment, a sensor for sensing concentrations of nitric oxide comprises a selectively permeable membrane configured to permit the diffusion of nitric oxide. The sensor also may comprise a membrane-dispersed solid electrolyte configured to stabilize the nitric oxide to form stable, oxidizable nitric oxide complexes. Further, the sensor generally comprises one or more reference electrodes configured to oxidize substances other than the nitric oxide complexes and one or more sensing electrodes configured to oxidize the nitric oxide complexes. The sensor further may comprise a picoammeter configured to measure electrical currents generated by the oxidations of the nitric oxide complexes, wherein the picoammeter signals to a user of the sensor the concentrations of nitric oxide.

In accordance with another embodiment, a method of measuring nitric oxide generally comprises the following steps: introducing a sample comprising nitric oxide to a sensor for measuring the concentration of nitric oxide in the sample; precluding with a selectively permeable membrane the substantial permeation of other substances into the sensor that interfere with the oxidation of nitric oxide; stabilizing the nitric oxide with a dispersed solid electrolyte configured as a nitric oxide trapping agent to form stable and oxidizable nitric oxide complexes, wherein the membrane comprises the solid electrolyte; oxidizing with a reference electrode substances that permeate the membrane other than nitric oxide complexes; oxidizing with a sensing electrode the nitric oxide complexes; transmitting with the sensor an electrical current indicative of the concentration of nitric oxide to a picoammeter; and signaling with the picoammeter to a user of the sensor the concentration of nitric oxide.

Accordingly, it is an object of the present invention to present embodiments of sensors configured to sense concentrations of nitric oxide. Other objects of the present invention will be apparent in light of the description of the invention embodied herein.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 is a cross-sectional illustration of an amperometric sensor in accordance with one embodiment of the present invention.

FIG. 2 is a schematic illustration of an amperometric sensor in accordance with a further embodiment of the present invention.

### DETAILED DESCRIPTION OF THE INVENTION

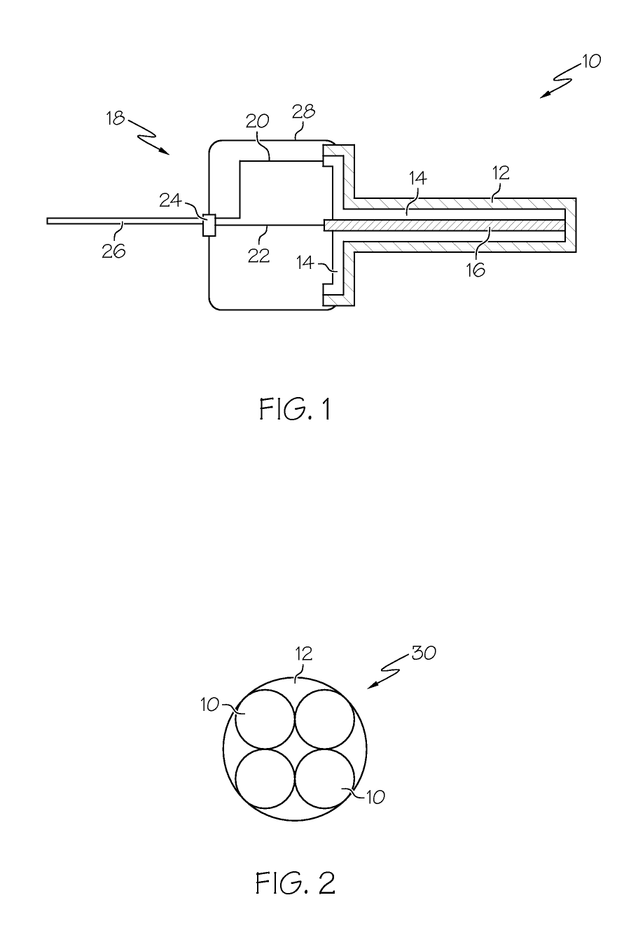

The present invention generally relates to a portable amperometric sensor configured to sense concentrations of nitric oxide. Referring initially to FIG. 1, embodiments of an amperometric sensor 10 generally comprise a membrane 12, a reference electrode 14, and a sensing electrode 16.

The membrane 12 is selectively permeable such that the membrane 12 is configured to permit the diffusion of nitric oxide. The membrane 12 also generally comprises a dispersed solid electrolyte. This solid electrolyte is a nitric oxide trapping agent configured to stabilize the nitric oxide by forming stable, oxidizable nitric oxide complexes. These nitric oxide complexes are formed upon reaction of the trapping agent with the nitric oxide.

The reference electrode 14 is semi-permeable such that the reference electrode 14 is configured to permit the diffusion of the nitric oxide complexes to the sensing electrode 16. The reference electrode 14 may also be configured to oxidize substances other than the nitric oxide complexes. This oxidation of the other substances substantially eliminates interference caused by the other substances in the oxidation of the nitric oxide complexes.

The sensing electrode 16 is configured to oxidize the nitric oxide complexes. This oxidation of the nitric oxide complexes generates an electrical current indicative of the concentration of nitric oxide.

The nitric oxide sensors 10 of the present invention may be used in a variety of contexts. For example, but not by way of limitation, an embodiment may be used to identify individuals with probable asthma, particularly very young children with airway inflammation. Early detection of an asthmatic condition may enable a health care provider to appropriately treat the condition before the individual experiences adverse affects in lung function. Research-based evidence suggests that the higher the concentration of nitric oxide (NO) in an individual's exhalation, the more likely the individual is to suffer from an asthmatic condition. Further, other embodiments may be configured to differentiate between asthma and other conditions that mimic asthma, such as, but not limited to, post-nasal drainage, gastroesophageal reflux, vocal cord dysfunction, and Chronic Obstructive Pulmonary Disease (COPD). In addition, embodiments described herein may help the clinician determine whether patient's medication regimen needs to be increased or decreased and is useful for monitoring overall control of the condition. As such, durable and accurate nitric oxide sensors capable of detecting parts-per-billion (ppb), and lower, concentrations of nitric oxide are needed.

The sensors 10 embodied herein utilize an electrochemical method to oxidize nitric oxide and thereby generate electrical currents indicative of the concentration of nitric oxide. The sensor 10 is configured such that the membrane 12 encapsulates portions of the reference and sensing electrodes 14, 16 exposed from a sealing cap 28, described in greater detail below. Further, the sensing electrode 16 may be centrally positioned in the sensor 10. Thereby, the reference electrode 14 may be positioned between the membrane 12 and the sensing electrode 16. The sensor 10, and the corresponding sealing cap 28, generally comprise a circular cross-sectional profile. It is contemplated, however, that the sensor 10, and the sealing cap 28, may comprise a non-circular cross-sectional profile. In addition, the sensor 10 typically, but not necessarily, measures about 5 mm in width. It is further contemplated that not only may the sensor 10 may be larger in width, but also that the sensor 10 may be smaller in width as circuitry continues to condense in size with technological advances, thereby enabling electrical coupling to electrodes on even smaller scales.

The sensor 10 further may comprise an insulating material. This insulating material is configured to insulate the reference electrode 14 from the sensing electrode 16 so as to substantially eliminate interference between the electrodes 14, 16. Therefore, the insulating material is permeable to the nitric oxide complexes so as not to interfere with the oxidation of the nitric oxide complexes by the sensing electrode 16. The insulating material may be provided by any flexible and durable insulating material known in the art. For example, but not of limitation, the insulating material may be wax paper.

Further, the sensor 10 generally comprises circuitry 18. This circuitry 18 is configured to electrically couple the sensor 10 to a picoammeter. Thereby, the circuitry 18 transmits the oxidation-generated electrical currents of the reference and sensing electrodes 14, 16 from the sensor 10 to the picoammeter. In one embodiment, the circuitry 18 comprises respective conductive elements 20, 22 electrically coupled to the reference and sensing electrodes 14, 16. The conductive elements 20, 22 also may be electrically coupled to an external cable 26 via a suitable terminal 24. The cable 26 may then connect the sensor 10 to the picoammeter and to a voltage source for the sensor 10. The voltage source generally is configured to provide electric potential to the electrodes 14, 16. The picoammeter may be configured to measure the oxidation-generated electrical currents and to signal to a user of the sensor 10 the concentration of nitric oxide. It is contemplated that the herein described electrical coupling of the sensor 10 to the picoammeter is only one example and that any circuitry capable of completing this electrical coupling may be utilized.

The sensor 10 may further comprise a sealing cap 28. This sealing cap 28 forms an impermeable seal about a portion of the sensor 10 where the sensor 10 is electrically coupled to circuitry 18. Further, the sealing cap 28 is configured to preclude substances from entering the electrically coupling portion of the sensor 10.

The membrane 12, shown in FIG. 1, generally is configured of a fluoropolymer. Fluoropolymers generally are characterized as possessing extremely high resistance to solvents, acids, and bases. Therefore, a fluoropolymer membrane provides a strong and durable membrane suitable for use with amperometric nitric oxide sensors 10 embodied herein. In one embodiment, the membrane 12 of the sensor 10 is configured of polytetrafluoroethylene (PTFE), which is commonly referred to as Teflon®. In another embodiment, the membrane 12 is configured of polyvinylidine (PVDF), which is commonly referred to as KYNAR®. It is contemplated that membranes configured of materials other than fluoropolymer possessing similar characteristics and suitable for the amperometric sensing of nitric oxide may be utilized.

The selectively permeable membrane 12 permits the diffusion of nitric oxide through the membrane 12. Other biologically relevant substances also may be permitted to diffuse through the selectively permeable membrane 12. Such biologically relevant substances include, but are not limited to, nitrogen, oxygen, carbon monoxide, carbon dioxide, and nitrogen dioxide. These biologically relevant substances generally possess different electric potentials than that of nitric oxide and, thus, typically do not interfere with the oxidation of nitric oxide. Further, as described in greater detail below, the reference electrode 14 may be configured to oxidize the biologically relevant substances other than nitric oxide complexes. Thereby, only the nitric oxide complexes diffuse through the reference electrode 14 and are oxidized by the sensing electrode 16.

It is contemplated that high concentrations of carbon dioxide may lower the pH of the solid electrolyte dispersed throughout the membrane 12 and, thus, potentially may interfere with the nitric oxide oxidation. Such interference, however, generally only occurs with a substantial change in concentration of carbon dioxide over a relatively short period of time. When sensing nitric oxide derived from physiological systems, the concentration of dissolved carbon dioxide generally remains substantially constant and, thus, may affect only a baseline nitric oxide concentration sensed by the sensor 10.

Other substances, however, may interfere with the oxidation of nitric oxide. To substantially eliminate such interference, the selectively permeable membrane 12 is configured to encapsulate the portions of the reference and sensing electrodes 14, 16 exposed from the sealing cap 28 described above. Thereby, the selectively permeable membrane 12 prevents the substantial diffusion of such interfering substances to the electrodes 14, 16. For example, charged molecules that may interfere with the nitric oxide oxidation, such as nitrite (NO₂⁻) and ascorbate, may be precluded from substantially diffusing through the membrane 12. Further, the membrane 12 may be a hydrophobic membrane such that the membrane 12 is substantially impermeable to water vapor. A hydrophobic membrane 12 prevents the diffusion of substantial water vapor to the electrodes 14, 16 and precludes substantial interference of water vapor with the oxidation of the nitric oxide.

The restriction of interfering substances by the membrane 12 from diffusing to the electrodes 14, 16 enhances the accuracy of the nitric oxide concentrations sensed by the sensor 10. More particularly, as mentioned above, the oxidation of nitric oxide generates an electric current indicative of the concentration of nitric oxide. Therefore, the greater the concentration of nitric oxide oxidized by the sensor 10, the stronger the current generated. The molar solubility of nitric oxide at the exterior surface of the membrane 12 controls the diffusion rate of nitric oxide though the membrane 12 and, thus, ultimately controls how much of the nitric oxide actually diffuses to the sensing electrode 16 and is oxidized. An equation for molar solubility may be defined as: Sp=k×P_{NO}, where Sp is the molar solubility of nitric oxide diffused within the membrane, k is a constant variable, and P_{NO} is the partial pressure of gaseous nitric oxide. The partial pressure of nitric oxide may vary according to temperature and the presence of interfering substances. Therefore, by restricting the diffusion of interfering substances, the partial pressure of nitric oxide increases, thereby increasing the molar solubility of nitric oxide. The higher the molar solubility of nitric oxide, the more completely the nitric oxide diffuses through the membrane 12. Consequently, the higher the molar solubility of the nitric oxide, the greater the concentration of nitric oxide exposed to the solid electrolyte and, thus, the greater the concentration of nitric oxide oxidized by the sensing electrode 16 of the sensor 10. This further enhances the accuracy of the concentrations of nitric oxide sensed by the sensor 10.

As mentioned above, the membrane 12 generally comprises a dispersed solid electrolyte. Generally, an electrolyte is a substance that serves as an electrically conductive medium. Solid electrolytes utilized with a sensor 10 embodied by the present invention, or other similar sensing, oxidizing, or conducting devices, generally possess a long useful life, thereby lengthening the functional life of the sensors and devices. The long useful life of a solid electrolyte generally is attributable to the solid state of the electrolyte and, due to its physical structure and composition, the elimination of the potential gain or loss of a solvent or other fluid that may occur over time with aqueous or gaseous electrolytes. As such, a solid electrolyte maintains its original structure and composition and, therefore, its functionality for a substantial length of time. In addition, a nitric oxide sensor utilizing a solid electrolyte is easily transported, maintained, and used.

Here, the solid electrolyte is a nitric oxide trapping agent. This trapping agent may be configured as a powder, wherein the powder may be dispersed throughout the membrane 12 during membrane formation. As mentioned above, the membrane 12 generally comprises the dispersed solid electrolyte, or trapping agent. The trapping agent may be water insoluble such that the trapping agent is not substantially compromised by a presence of water vapor. The trapping agent may be, but is not limited to, an iron dithiocarbamate complex. Dithiocarbamate (DTC) derivatives form various complexes with the iron (Fe) ion, such as, but not limited to, planar Fe(II)(DTC)₂, octahedral Fe(II)(DTC)₃, Fe(III)(DTC)₃, and Fe(IV)(DTC)₃, where the total charge on these complexes is omitted.

In order to accurately sense the concentration of nitric oxide derived from a physiological system, the nitric oxide must be stabilized within a short period of time following its derivation from the physiological system. Gaseous nitric oxide is an extremely volatile compound and, as such, rapidly dissipates outside of physiological conditions. Therefore, as a sample comprising nitric oxide is introduced to the sensor 10 and the nitric oxide diffuses through the membrane 12, the nitric oxide must be stabilized quickly by another substance prior to the nitric oxide's dissipation. Once stabilized, the nitric oxide generally maintains it's structure (in a stabilized form) and may be oxidized by the sensor 10.

The trapping agent is configured to stabilize the nitric oxide by forming stable, oxidizable nitric oxide complexes. These nitric oxide complexes are formed upon reaction of the trapping agent with the nitric oxide as the nitric oxide diffuses through the membrane 12. By way of example only, an iron dithiocarbamate trapping agent may react with nitric oxide to form a stable, oxidizable nitric oxide complex (Fe(II)(NO)(DTC)₂), even in the absence of oxygen. The rate constant of this reaction generally is (1.1±0.3)×10⁸ M⁻¹s^{31 1}, the only product of this reaction being the nitric oxide complex. This nitric oxide complex generally exhibits a characteristic three-line EPR (Electron Paramagnetic Resonance) spectrum. EPR is a spectroscopic technique that detects molecules having unpaired electrons. Here, the spectrum may indicate that the nitric oxide complex has one or more transition metal ions.

Further, the stabilization of the nitric oxide by the trapping agent facilitates the diffusion of the nitric oxide, in the form of the nitric oxide complexes, through the membrane 12 and the reference electrode 14. Generally, the reference electrode 14 is located immediately beneath, the membrane 12. This reference electrode 14 may be a flexible Silver/Silver Chloride (Ag/AgCl) electrode. It is contemplated, however, that the reference electrode 14 may be any other electrode having similar properties and characteristics that may function with an amperometric sensor.

The reference electrode 14 is permeable to the nitric oxide complexes. Thus, the reference electrode 14 is configured to permit the nitric oxide complexes to diffuse there-through to the sensing electrode 16. Further, the reference electrode 14 also may be configured to oxidize substances other than the nitric oxide complexes that have diffused through the membrane 12. This oxidation of the other substances by the reference electrode 14 substantially eliminates interference that may be caused by these other substances in the oxidation of the nitric oxide complexes. Thus, after the nitric oxide complexes and the other permeating substances diffuse through the membrane 12, the nitric oxide complexes diffuse through the reference electrode 14, while the other substances are oxidized by the reference electrode 14. More particularly, the reference electrode 14 may be configured to oxidize substances carrying electric potential different than that held by the nitric oxide complexes. An electric current generated by the oxidation at the reference electrode 14 may be monitored and later deducted from the current generated by the oxidation of the nitric oxide complexes at the sensing electrode 16, as described below. This results in an accurate measurement of the concentration of nitric oxide based on an analysis of the oxidation-generated currents of the sensor 10.

The sensing electrode 16 generally is a flexible carbon fiber electrode, such as, but not limited to, a flexible composite graphite electrode. This sensing electrode 16 typically, but not necessarily, measures between about 10 μm and 200 μm in width. It is contemplated that the sensing electrode 16 may be even smaller in width. The sensing electrode 16 comprises a sensing surface comprising an area sufficient for the sensing electrode 16 to sense sub-molar concentrations of nitric oxide.

The sensing electrode 16 is configured to oxidize the nitric oxide complexes after they diffuse through the reference electrode 14. As such, the sensing electrode 16 generally is maintained by the voltage source at a potential sufficient to rapidly and continuously oxidize the nitric oxide complexes during a patient assessment or other test. Such potential may be, but is not limited to, between about 0.7 volts and about 1.3 volts. The oxidation of the nitric oxide complexes generates an electrical current indicative of the concentration of nitric oxide. This current may then be transmitted from the sensing electrode 16 through the circuitry 18 to the picoammeter, where the current may be measured. Thereby, the picoammeter may signal to the user of the sensor 10 the concentration of nitric oxide.

Referring to FIG. 2, in accordance with another embodiment, a more complex sensor 30 generally comprises a matrix of the above-described sensors 10. For example, but not of limitation, a complex sensor 30 may comprise four individual sensors 10, all substantially encapsulated by a single selectively permeable membrane 12, yet each comprising a reference electrode 14, sensing electrode 16, and circuitry 18. Such an embodiment magnifies nitric oxide oxidization and measurement in order to more accurately measure concentrations of nitric oxide. In addition, a complex sensor 30 embodiment may reduce the amount of interfering noise received and projected by the picoammeter in signaling to the user of the sensor 30 the concentrations of nitric oxide.

It is noted that terms like “generally,” “typically,” and “exemplary” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. An amperometric sensor comprising:
a selectively permeable membrane, wherein:
the membrane is configured to permit the diffusion of nitric oxide through the membrane;
the membrane comprises a dispersed solid electrolyte;
the solid electrolyte is a nitric oxide trapping agent configured to stabilize the nitric oxide by forming stable, oxidizable nitric oxide complexes upon reaction of the trapping agent with the nitric oxide;
a semi-permeable reference electrode configured to:
permit the diffusion of the nitric oxide complexes to the sensing electrode;
oxidize substances other than the nitric oxide complexes so as to substantially eliminate interference caused by the other substances in the oxidation of the nitric oxide complexes; and
a sensing electrode configured to oxidize the nitric oxide complexes, wherein the oxidation generates an electrical current indicative of the concentration of nitric oxide.

2. The sensor of claim 1, wherein the membrane is a hydrophobic membrane such that the membrane is substantially impermeable to water vapor.

3. The sensor of claim 1, wherein the membrane is configured as a hydrophobic, electrode-encapsulating membrane such that the membrane:
prevents the diffusion of substantial water vapor to the reference and sensing electrodes; and
precludes substantial interference of the water vapor with the oxidation of the nitric oxide complexes by the sensing electrode.

4. The sensor of claim 1, wherein the selectively permeable membrane prevents the substantial diffusion of substances to the reference and sensing electrodes that may interfere with the oxidation of nitric oxide by the sensor.

5. The sensor of claim 1, wherein the selectively permeable membrane is configured to permit the diffusion of biologically relevant substances comprising nitrogen, oxygen, carbon monoxide, carbon dioxide, and nitrogen dioxide.

6. The sensor of claim 1, wherein the membrane is configured of a fluoropolymer.

7. The sensor of claim 6, wherein the membrane is configured of polytetrafluoroethylene (PTFE).

8. The sensor of claim 6, wherein the membrane is configured of polyvinylidine difluoride (PVDF).

9. The sensor of claim 1, wherein:
the trapping agent is configured as a powder; and
the powder is dispersed throughout the membrane during membrane formation.

10. The sensor of claim 1, wherein the trapping agent is water insoluble such that the trapping agent is not substantially compromised by a presence of water vapor.

11. The sensor of claim 1, wherein the trapping agent is an iron dithiocarbamate complex.

12. The sensor of claim 1, wherein the sensing electrode is a flexible carbon fiber electrode measuring between about 10 μm and about 200 μm in width.

13. The sensor of claim 12, wherein the sensing electrode is a flexible composite graphite electrode.

14. The sensor of claim 1, wherein the sensing electrode comprises a sensing surface comprising an area sufficient for the sensing electrode to sense sub-micromolar concentrations of nitric oxide.

15. The sensor of claim 1, wherein the reference electrode is a flexible Ag/AgCl electrode.

16. The sensor of claim 1, wherein:
the membrane encapsulates portions of the reference and sensing electrodes exposed from a sealing cap of the sensor;
the sensing electrode is centrally positioned in the sensor; and
the reference electrode is positioned between the membrane and the sensing electrode.

17. The sensor of claim 16, wherein the sealing cap:
forms an impermeable seal about a portion of the sensor where the sensor is electrically coupled to circuitry; and
is configured to preclude substances from entering the electrically coupling portion of the sensor.

18. The sensor of claim 1, wherein an insulating material insulates the reference electrode from the sensing electrode so as to preclude substantial interference between the electrodes.

19. wherein:
the sensor comprises circuitry; and
the circuitry is configured to electrically couple the sensor to a picoammeter such that the circuitry transmits the oxidation-generated electrical currents of the reference and sensing electrodes from the sensor to the picoammeter.

20. The sensor of claim 19, wherein:
the circuitry comprises respective conductive elements electrically coupled to the reference and sensing electrodes;
a terminal electrically couples the conductive elements to an external cable; and
the cable connects the sensor to the picoammeter and to a voltage source for the sensor.

21. The sensor of claim 19, wherein the picoammeter is configured:
to measure the oxidation-generated electrical currents; and
to signal to a user of the sensor the concentration of nitric oxide.

22. A sensor for sensing concentrations of nitric oxide, the sensor comprising:
a selectively permeable membrane configured to permit the diffusion of nitric oxide;
a membrane-dispersed solid electrolyte configured to stabilize the nitric oxide to form stable, oxidizable nitric oxide complexes;
one or more reference electrodes configured to oxidize substances other than the nitric oxide complexes;
one or more sensing electrodes configured to oxidize the nitric oxide complexes; and
one or more picoammeters configured to measure oxidation-generated electrical currents of the reference and sensing electrodes, wherein the picoammeters signal to a user of the sensor the concentrations of nitric oxide.

23. A method of measuring nitric oxide, the method comprising the steps of:
introducing a sample comprising nitric oxide into a sensor for measuring the concentration of nitric oxide in the sample;
precluding with a selectively permeable membrane the substantial permeation of other substances into the sensor that interfere with the oxidation of nitric oxide;
stabilizing the nitric oxide with a solid electrolyte configured as a nitric oxide trapping agent to form stable and oxidizable nitric oxide complexes, wherein the membrane comprises the solid electrolyte;
oxidizing with a reference electrode substances other than the nitric oxide complexes that permeate the membrane;
oxidizing with a sensing electrode the nitric oxide complexes;
transmitting with circuitry an electrical current indicative of the concentration of nitric oxide from the sensor to a picoammeter; and
signaling with the picoammeter to a user of the sensor the concentration of nitric oxide in the sample.

24. The method of claim 23, wherein the sample is an exhalation.
